(19) United States
(12) Patent Application Publication
(10) Pub. No.: US 2008/0189925 A1
(43) Pub. Date: Aug. 14, 2008

(54) Method for making water buffer device

(75) Inventor: Ho Shan Huang, Changhua Hsien (TW)

Correspondence Address: CHARLES E. BAXLEY, ESQUIRE, 90 JOHN STREET, SUITE 309, NEW YORK, NY, 10038, US

(73) Assignee: Taho Valves Corporation

(21) Appl. No.: 11/210,069

(22) Filed: Aug. 23, 2005

(51) Int. Cl. B23P 11/00

(52) U.S. Cl. 29/428

(57) ABSTRACT

A method for manufacturing a water buffer device includes attaching a housing to a tubing for receiving a water from the tubing, slidably disposing a piston in the housing, attaching an end cap to one end of the housing and forming an orifice in the end cap for communicating with the housing, and filling a pressurized air into the housing to force the piston toward the other end of the housing. A plug may selectively block the orifice of the end cap when the pressurized air has been filled within the housing. The piston is movable toward the end cap against the pressurized air by the water from the tubing, for absorbing the water pressure in the tubing when the tubing is switched off, and for reducing vibration or shaking.

### BACKGROUND OF THE INVENTION

1. Field of the Invention

The present invention relates to a water buffer or damping device, and more particularly to a method for making a water buffer or damping device which is provided for attaching to a tubing, and for absorbing the water pressure in the tubing when the tubing is closed or switched off, and for preventing shaking or vibration from being generated within the tubing, or for reducing shock or shaking or vibration.

2. Description of the Prior Art

Typical water tubing or plumbing facilities or systems comprise one or more water devices, such as water tanks, water reservoirs, water heaters, etc., and a tubing coupled between the water devices, and may further comprise one or more control valves attached to or coupled to the tubing, for controlling the water to flow through the tubing and the water devices.

Normally, the water may be forced to flow through the tubing and the water devices in a predetermined flowing speed, and may generate a great pressure within the tubing and the water devices, particularly when the tubing and/or the water devices are closed or switched off, such that shocks or shakings or vibrations may be generated within the tubing and/or the water devices when the tubing and/or the water devices are closed or switched off.

After use, or after the tubing and/or the water devices are closed or switched off for several times, the shocks or shakings or vibrations generated within the tubing and/or the water devices may cause the tubing and/or the water devices and/or the control valves to become loose relative to each other, such that water leaking problems may thus be occurred.

The present invention has arisen to mitigate and/or obviate the afore-described disadvantages of the conventional water tubing members and water devices.

### SUMMARY OF THE INVENTION

The primary objective of the present invention is to provide a method for making a water buffer or damping device which is provided for attaching to a tubing, and for absorbing the water pressure in the tubing particularly when the tubing is closed or switched off, and for preventing shocks or shaking or vibrations from being generated within the tubing, or for reducing shock or shaking or vibration.

In accordance with one aspect of the invention, there is provided a method for manufacturing a water buffer device which is provided for attaching to a tubing, the method comprising preparing a housing including a chamber formed therein and defined by an outer peripheral wall, and including a first end, and including a second end for attaching to the tubing and for allowing a water to flow from the tubing into said chamber of said housing, slidably disposing a piston in said chamber of said housing, attaching an end cap to said first end of said housing, said end cap including an orifice formed therein and communicating with said chamber of said housing, filling a pressurized air into said chamber of said housing via said orifice of said end cap, for forcing and moving said piston toward and within said second end of said housing, and slidably attaching a plug to said end cap, for selectively blocking said orifice of said end cap by the pressurized air when the pressurized air has been filled within said chamber of said housing. The piston is movable toward the end cap against the pressurized air by the water from the tubing, for absorbing the water pressure in the tubing when the tubing is closed or switched off, and for preventing shocking or shaking or vibration from being generated within the tubing.

The end cap includes an inner compartment formed therein and defined by an end panel, the orifice is formed in the end panel and communicating with the inner compartment of the end cap and thus the chamber of the housing, for allowing the pressurized air to be filled into the chamber of the housing via the inner compartment of the end cap.

The blocking device includes a plug slidably received in the inner compartment of the end cap, for selectively blocking the orifice of the end cap by the pressurized air when the plug moves toward and engages with the end panel.

The end cap includes a peripheral rib extended radially and inwardly therefrom, for selectively engaging with the plug, and for slidably retaining the plug within the inner compartment of the end cap, and for preventing the plug from being disengaged from the end cap.

The end cap includes at least one passage formed therein and communicating with the inner compartment of the end cap, and arranged for allowing the pressurized air to flow from the inner compartment of the end cap into the chamber of the housing via the passage of the end cap when the plug is spaced away from the orifice of the end cap. The passage of the end cap is formed through the peripheral rib of the end cap.

The housing includes an inner peripheral shoulder formed in the first end thereof, the end cap is engaged with the peripheral shoulder of the housing, for being positioned and retained within the first end of the housing.

The outer peripheral wall at the first end of the housing is bent inwardly to form an end cover and to engage with the end cap, for retaining the end cap within the first end of the housing. The end cover is engage with the end cap for blocking the orifice of the end cap.

The housing includes a coupler attached to the second end thereof, for attaching the housing to the tubing, the coupler includes a bore formed therein and communicating with the chamber of the housing, for allowing the water to flow from the tubing into the chamber of the housing via the bore of the coupler.

The coupler includes a valve seat provided therein, the piston is selectively engaged with the valve seat of the coupler, for selectively blocking the bore of the coupler. The piston includes a blind hole formed therein and defined by an end plate which is faced toward the bore of the coupler, for selectively engaging with the valve seat of the coupler, and for selectively blocking the bore of the coupler.

The coupler includes an outer thread formed thereon, for attaching to the tubing. The coupler includes a non-circular segment provided thereon, for engaging with a driving tool and for thus for allowing the coupler to be rotated relative to the tubing with such as the driving tool.

The end cover is preferable a peripheral end cover to engage with the end cap without enclosing and blocking the orifice of the end cap, for receiving and retaining the end cap within the first end of the housing, and a lid may then be engaged into the peripheral end cover and may then be secured to the end cover and/or secured to the first end of the housing, for enclosing and blocking the orifice of the end cap.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view illustrating the operation of a water buffer device to be made with a method in accordance with the present invention;

FIG. 2 is an enlarged cross sectional view of the water buffer device;

FIG. 3 is a perspective view of the water buffer device, in which one quarter of the water buffer device has been cut off for showing an inner structure of the water buffer device;

FIG. 4 is a perspective view similar to FIG. 3, illustrating the other arrangement of the water buffer device;

FIG. 5 is an exploded view of the water buffer device;

FIG. 6 is an enlarged partial perspective view illustrating an end cap of the water buffer device, in which one quarter of the end cap has also been cut off for showing an inner structure of the end cap;

FIGS. 7, 8, 9, 10 are cross sectional views similar to FIG. 2, illustrating the manufacturing or the formation processes for manufacturing the water buffer device;

FIGS. 11, 12, 13, 14 are cross sectional views similar to FIGS. 7-10, illustrating the manufacturing or the formation processes for manufacturing the other arrangement of the water buffer device; and

FIG. 15 is a cross sectional view similar to FIG. 1, illustrating the operation of the water buffer device.

### DETAILED DESCRIPTION OF THE PREFERRED EMBODIMENT

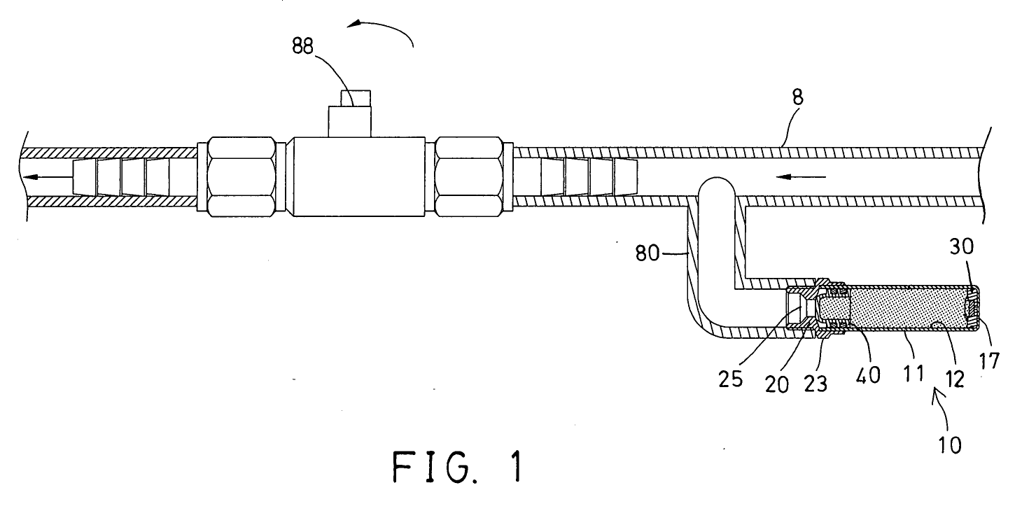

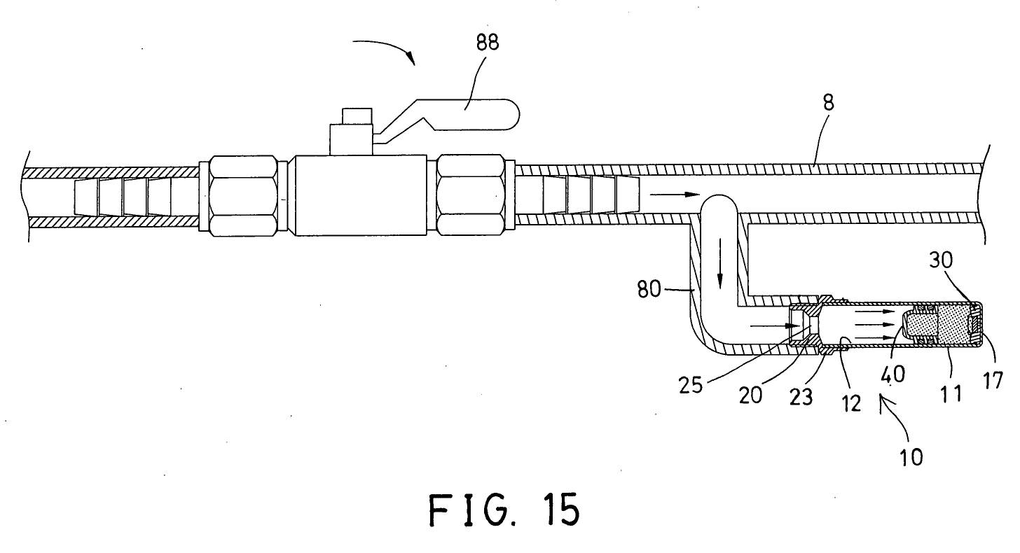

Referring to the drawings, and initially to FIGS. 1-5, a water buffer or damping device 10 to be made with a method in accordance with the present invention is provided for attaching to a tubing 8 (FIGS. 1, 15), such as a manifold 80 of the tubing 8, and for absorbing the water pressure in the tubing 8, particularly when the tubing 8 is closed or switched off with such as a control valve 88, and for preventing shocks, shaking or vibrations from being generated within the tubing 8.

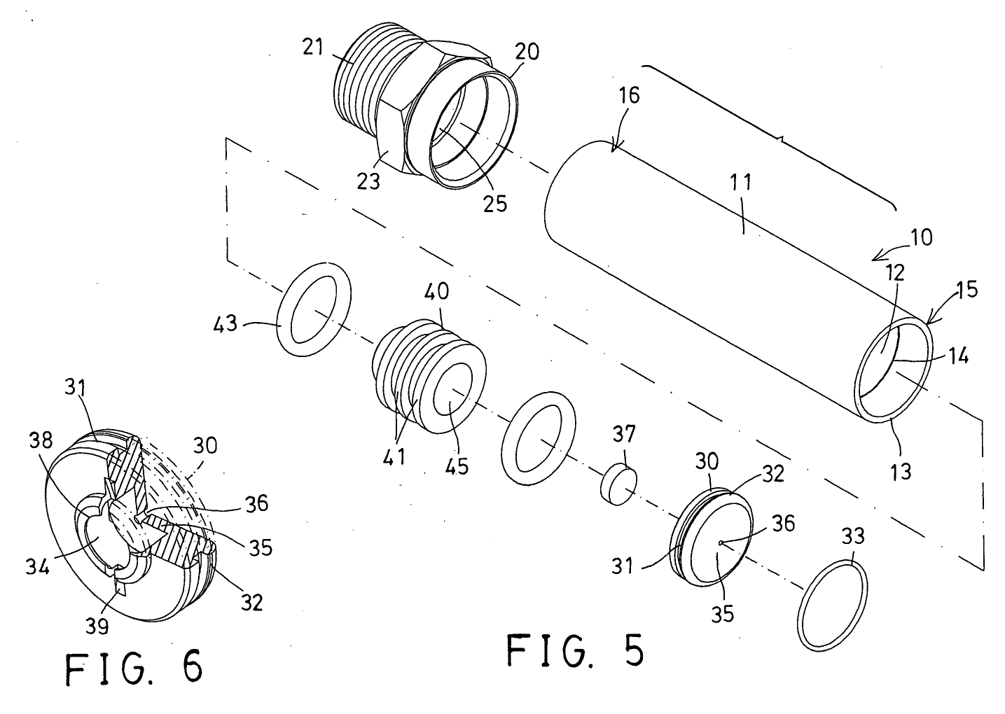

The water buffer device 10 comprises an outer housing 11 including a hollow chamber 12 formed therein, and defined by an outer peripheral wall 13, and including an inner peripheral shoulder 14 formed in one end or first end 15 thereof (FIG. 5), and including another or an opposite end or second end 16 having a coupler 20 attached or secured thereto, for coupling or attaching to the tubing 8, such as to the manifold 80 of the tubing 8.

For example, the coupler 20 may be attached or secured onto the other end 16 of the outer housing 11 with such as a force-fitted engagement, adhesive materials, or by welding processes, etc., and includes an outer thread 21 formed thereon, for threading and securing to such as the manifold 80 of the tubing 8, and includes a non-circular segment 23 formed or provided thereon, for engaging with a driving tool (not shown), which may be used to rotate the coupler 20 relative to the manifold 80 of the tubing 8.

The coupler 20 further includes a bore 25 formed thereon and communicating with the hollow chamber 12 of the outer housing 11, for allowing the water to flow from the manifold 80 of the tubing 8 into the hollow chamber 12 of the outer housing 11 via the bore 25 of the coupler 20, best shown in FIG. 15, or for allowing the water to flow backwardly from the hollow chamber 12 of the outer housing 11 into the manifold 80 of the tubing 8 via the bore 25 of the coupler 20.

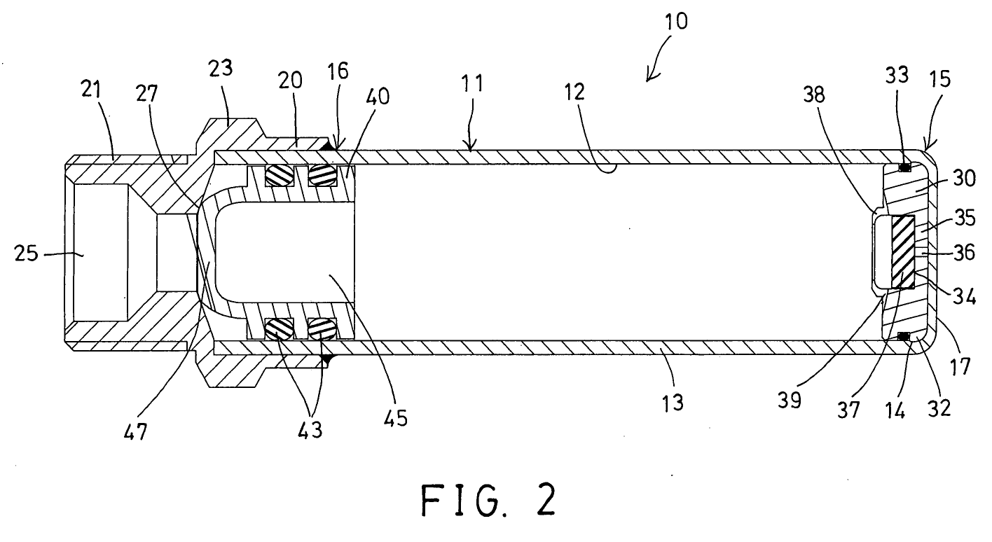

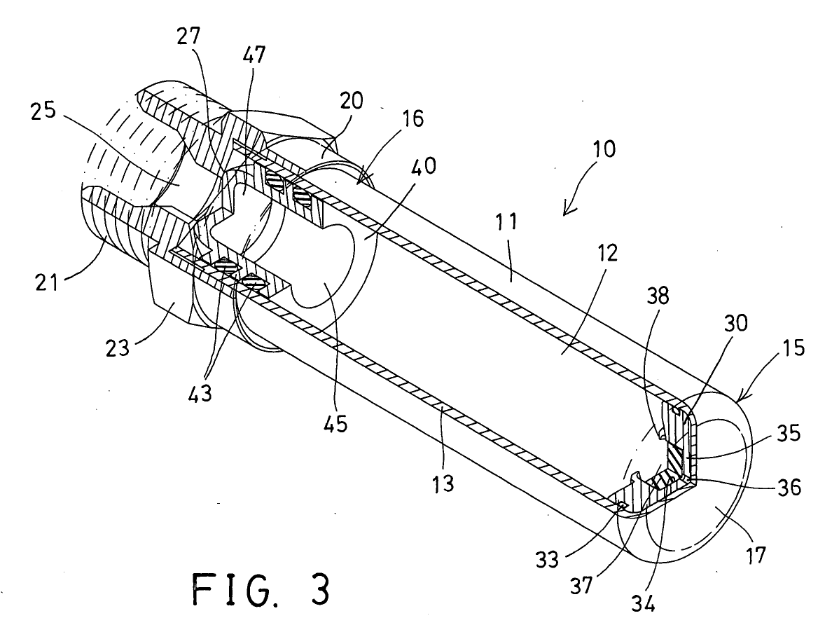

An end cap 30 is engaged into the one end 15 of the outer housing 11, and engaged with the peripheral shoulder 14 of the outer housing 11 (FIG. 2), for being positioned and retained within the one end 15 of the outer housing 11, and the outer peripheral wall 13 at the one end 15 of the outer housing 11 may then be bent or riveted or forged inwardly to form an end cover 17 (FIGS. 3, 9, 10), and to engage with the end cap 30, for solidly retaining or maintaining the end cap 30 within the one end 15 of the outer housing 11.

For example, the end cap 30 includes an outer peripheral recess 31 formed therein, and defined by an outer peripheral flange 32 which may be engaged with the peripheral shoulder 14 of the outer housing 11 (FIG. 2), for stably positioning and retaining the end cap 30 within the one end 15 of the outer housing 11, and retaining between or by the peripheral shoulder 14 of the outer housing 11 and the end cover 17 (FIGS. 1-3, 9-10, and 15). A sealing ring 33 may be engaged within the outer peripheral recess 31 of the end cap 30, for making a water tight seal between the outer housing 11 and the end cap 30.

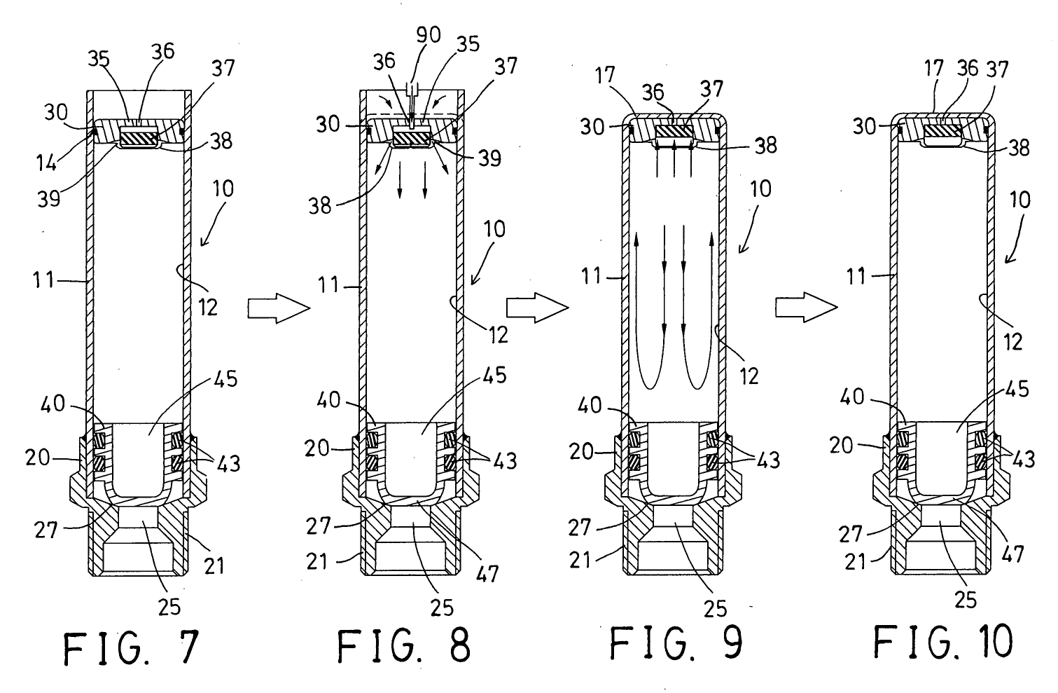

The end cap 30 further includes an inner compartment 34 formed therein, and defined by an end panel 35 which is located closer to the end cover 17 of the outer housing 11 then the inner compartment 34 of the end cap 30, and includes an orifice 36 formed therein, such as formed in the end panel 35 and communicating with the inner compartment 34 of the end cap 30 and thus the hollow chamber 12 of the outer housing 11, for allowing pressurized air or gas to be supplied or filled into the hollow chamber 12 of the outer housing 11 via the inner compartment 34 of the end cap 30, with such as a supplying nozzle 90 (FIGS. 8, 12).

A plug 37 is slidably received in the inner compartment 34 of the end cap 30, for selectively blocking the orifice 36 of the end cap 30 when the plug 37 moves toward and engages or contacts with the end panel 35 (FIGS. 9-10 and 13-14), and the end cap 30 includes a peripheral rib 38 extended radially and inwardly therefrom, for selectively engaging with the plug 37, and for slidably receiving and retaining the plug 37 within the inner compartment 34 of the end cap 30, and for preventing the plug 37 from being disengaged from the end cap 30.

The end cap 30 further includes one or more passages 39 formed therein, such as formed through the peripheral rib 38, and communicating with the inner compartment 34 of the end cap 30, and arranged for allowing the pressurized air or gas to flow from the inner compartment 34 of the end cap 30 into the hollow chamber 12 of the outer housing 11 via the passages 39 of the end cap 30 (FIGS. 8, 12), when the plug 37 is engaged with the peripheral rib 38 or spaced away from the orifice 36 of the end cap 30.

A piston 40 slidably received in the hollow chamber 12 of the outer housing 11, and includes one or more outer peripheral recesses 41 formed therein (FIG. 5), each for receiving a sealing ring 43 therein, which may be provided for making a water tight seal between the outer housing 11 and the piston 40. The piston 40 may further include a blind hole 45 formed therein and defined by an end plate 47 which is preferably faced toward the bore 25 of the coupler 20, for selectively engaging with the valve seat 27 of the coupler 20 (FIGS. 2-4), and thus for selectively blocking the bore 25 of the coupler 20.

Alternatively, the valve seat 27 may also be formed in the other end 16 of the outer housing 11, instead of in the coupler 20, or, the outer housing 11 may include the valve seat 27 extended into the hollow chamber 12 thereof at the other end 16 thereof, for engaging with the piston 40, and for retaining the piston 40 within the other end 16 of the outer housing 11, and for preventing the piston 40 from being disengaged from the outer housing 11, but for allowing the piston 40 to be movable toward the end cap 30.

In assembling the end cap 30 and the piston 40 within the hollow chamber 12 of the outer housing 11, as shown in FIGS. 7-10, the piston 40 may first be engaged into the hollow chamber 12 of the outer housing 11, and the end cap 30 may then be engaged into the hollow chamber 12 of the outer housing 11 and engaged with the peripheral shoulder 14 of the outer housing 11 (FIGS. 2, 7). The supplying nozzle 90 may then be engaged into the orifice 36 of the end cap 30, for supplying or filling the pressurized air or gas into the hollow chamber 12 of the outer housing 11 via the inner compartment 34 and the passages 39 of the end cap 30 (FIG. 8), and for forcing and moving the piston 40 toward and within the other end 16 of the outer housing 11.

The piston 40 may thus be forced to engage with the valve seat 27 of the coupler 20 by the pressurized air or gas, in order to block the bore 25 of the coupler 20. When the pressurized air or gas has been filled within the hollow chamber 12 of the outer housing 11, the pressurized air or gas may then force the plug 37 to move toward and to engage or to contact with the end panel 35, so as to enclose or block the orifice 36 of the end cap 30 (FIG. 9), such that the pressurized air or gas may be filled and retained within the hollow chamber 12 of the outer housing 11 by both the end cap 30 and the piston 40. The plug 37 may be formed or may be taken as a blocking means or device for enclosing or blocking the orifice 36 of the end cap 30.

After the pressurized air or gas has been filled and retained within the hollow chamber 12 of the outer housing 11, the outer peripheral wall 13 at the one end 15 of the outer housing 11 may then be bent or riveted or forged inwardly to form the end cover 17 (FIGS. 8-10), and to engage with the end cap 30, for solidly retaining or maintaining the end cap 30 within the one end 15 of the outer housing 11, and thus for sealingly retain the pressurized air or gas within the hollow chamber 12 of the outer housing 11. The end cover 17 may also engage with and enclose or block the orifice 36 of the end cap 30.

It is to be noted that the end cap 30 may be forced to engage with the peripheral shoulder 14 of the outer housing 11 with other tool members or facilities (not shown), to allow the supplying nozzle 90 to easily engage into the orifice 36 of the end cap 30 and to supply or to fill the pressurized air or gas into the hollow chamber 12 of the outer housing 11.

Alternatively, the outer peripheral wall 13 at the one end 15 of the outer housing 11 may first be slightly bent or riveted or forged inwardly to slightly engage with the end cap 30 (FIG. 8), for temporarily retaining or maintaining the end cap 30 within the one end 15 of the outer housing 11, when the supplying nozzle 90 is engaged into the orifice 36 of the end cap 30 to supply or to fill the pressurized air or gas into the hollow chamber 12 of the outer housing 11. The outer peripheral wall 13 at the one end 15 of the outer housing 11 may then be bent or riveted or forged inwardly to completely engage with the end cap 30 (FIGS. 9-10), and to engage with and to enclose or to block the orifice 36 of the end cap 30 after the pressurized air or gas has been filled and retained within the hollow chamber 12 of the outer housing 11.

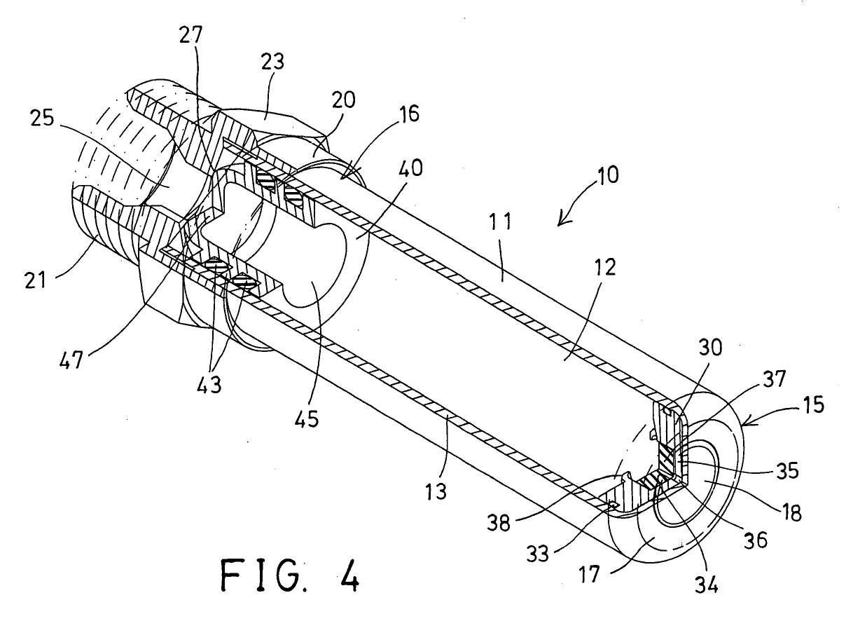

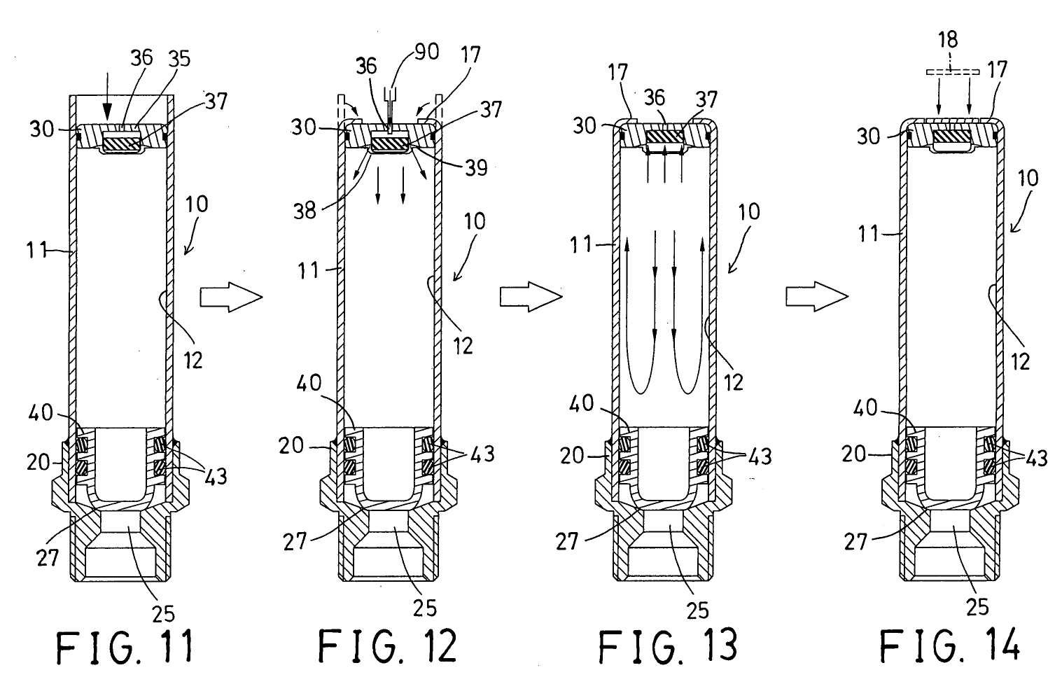

Further alternatively, as shown in FIGS. 4 and 11-14, the outer peripheral wall 13 at the one end 15 of the outer housing 11 may first be completely bent or riveted or forged inwardly to form a peripheral end cover 17 and to stably and solidly engage with the end cap 30 (FIGS. 12-13), without enclosing or blocking the orifice 36 of the end cap 30, for solidly retaining or maintaining the end cap 30 within the one end 15 of the outer housing 11, and for allowing the supplying nozzle 90 to easily engage into the orifice 36 of the end cap 30 and to readily supply or fill the pressurized air or gas into the hollow chamber 12 of the outer housing 11.

After the pressurized air or gas has been filled and retained within the hollow chamber 12 of the outer housing 11, a lid 18 may then be engaged into the peripheral end cover 17 (FIG. 14), and secured to the end cover 17 and secured to the one end 15 of the outer housing 11 with such as catches or fasteners (not shown), or by welding processes, for engaging or contacting with the end panel 35, and thus for enclosing or blocking the orifice 36 of the end cap 30 (FIG. 14).

In operation, as shown in FIG. 1, when the tubing 8 is opened by the control valve 88, to allow the water to flow through the tubing 8, the water will not flow into the manifold 80 of the tubing 8, such that the water will not apply the water pressure against the piston 40, and such that the piston 40 may be forced to maintain in engagement with the valve seat 27 of the coupler 20 by the pressurized air or gas received or retained within the hollow chamber 12 of the outer housing 11.

On the contrary, as shown in FIG. 15, when the tubing 8 is closed or switched off by the control valve 88, the water may no longer flow through the control valve 88, and may then be forced to flow into the manifold 80 of the tubing 8, and may thus apply the water pressure against the piston 40, in order to force and to move the piston 40 away from the valve seat 27 of the coupler 20, against the pressurized air or gas received or retained within the hollow chamber 12 of the outer housing 11, such that the water pressure may be released or absorbed or dissipated by the piston 40 and the pressurized air or gas, and such that the shocks or shaking or vibrations may be prevented from being generated within the tubing 8.

Accordingly, the water buffer device manufactured with the method in accordance with the present invention may be provided for attaching to a tubing, and for absorbing the water pressure in the tubing particularly when the tubing is closed or switched off, and for preventing shock or shaking or vibration from being generated within the tubing.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for manufacturing a water buffer device which is provided for attaching to a tubing, said method comprising:
preparing a housing including a chamber formed therein and defined by an outer peripheral wall, and including a first end, and including a second end for attaching to the tubing and for allowing a water to flow from the tubing into said chamber of said housing,
slidably disposing a piston in said chamber of said housing,
attaching an end cap to said first end of said housing, said end cap including an orifice formed therein and communicating with said chamber of said housing,
filling a pressurized air into said chamber of said housing via said orifice of said end cap, for forcing and moving said piston toward and within said second end of said housing, and
slidably attaching a plug to said end cap, for selectively blocking said orifice of said end cap by the pressurized air when the pressurized air has been filled within said chamber of said housing, and
said piston being movable toward said end cap against the pressurized air by the water from the tubing.

2. The water buffer device as claimed in claim 1 further comprising forming an inner compartment in said end cap to define an end panel, said orifice being formed in said end panel and communicating with said inner compartment of said end cap and thus said chamber of said housing, for allowing the pressurized air to be filled into said chamber of said housing via said inner compartment of said end cap.

3. The water buffer device as claimed in claim 1 further comprising forming a peripheral rib on said end cap, to selectively engage with said plug, and to slidably retain said plug within said inner compartment of said end cap, and for preventing said plug from being disengaged from said end cap.

4. The water buffer device as claimed in claim 3 further comprising forming at least one passage in said end cap and communicating said at least one passage with said inner compartment of said end cap, to allow the pressurized air to flow from said inner compartment of said end cap into said chamber of said housing via said at least one passage of said end cap when said plug is spaced away from said orifice of said end cap.

5. The water buffer device as claimed in claim 4, wherein said at least one passage of said end cap is formed through said peripheral rib of said end cap.

6. The water buffer device as claimed in claim 1 further comprising forming an inner peripheral shoulder in said first end of said housing, for engaging with said end cap and for positioning and retaining said end cap within said first end of said housing.

7. The water buffer device as claimed in claim 1 further comprising bending said outer peripheral wall at said first end of said housing inwardly to form an end cover and to engage with said end cap, and to retain said end cap within said first end of said housing.

8. The water buffer device as claimed in claim 7, wherein said end cover is bent to engage with said end cap and to block said orifice of said end cap.

9. The water buffer device as claimed in claim 1 further comprising attaching a coupler to said second end of said housing, for attaching said housing to the tubing, and forming a bore in said coupler and communicating with said chamber of said housing, for allowing the water to flow from the tubing into said chamber of said housing via said bore of said coupler.

10. The water buffer device as claimed in claim 9 further comprising forming a valve seat in said coupler, for selectively engaging with said piston, to allow said piston to selectively block said bore of said coupler.

11. The water buffer device as claimed in claim 10 further comprising forming a blind hole in said piston, and an end plate to define said blind hole and to selectively engage with said valve seat of said coupler, and to selectively block said bore of said coupler.

12. The water buffer device as claimed in claim 9 further comprising forming an outer thread on said coupler, for attaching to the tubing.

13. The water buffer device as claimed in claim 9 further comprising forming a non-circular segment on said coupler, for being rotated relative to the tubing with a driving tool.

14. The water buffer device as claimed in claim 1 further comprising bending said outer peripheral wall at said first end of said housing inwardly to form a peripheral end cover and to engage with said end cap without enclosing and blocking said orifice of said end cap, and to retain said end cap within said first end of said housing, and securing a lid to said end cover, to block said orifice of said end cap.
